(19) United States
(12) Patent Application Publication
(10) Pub. No.: US 2003/0031151 A1
(43) Pub. Date: Feb. 13, 2003

(54) System and method for secure roaming in wireless local area networks

(76) Inventors: Mukesh Sharma, McLean, VA (US); Christopher Skiscim, Dickerson, MD (US); Philip Roberts, Palatine, IL (US); Luis Sanchez, Mayaguez, PR (US)

Correspondence Address: McGLEW AND TUTTLE, P.C., SCARBOROUGH STATION, SCARBOROUGH, NY, 10510-0827, US

(21) Appl. No.: 09/928,290

(22) Filed: Aug. 10, 2001

(51) Int. Cl. H04Q 7/24; H04L 12/66

(52) U.S. Cl. 370/338; 370/349; 370/389; 370/401; 455/432

(57) ABSTRACT

A wireless data network process and system is provided including a mobile node with a wireless transceiver, a serving GPRS support node (SGPRS) a radio access network and a gateway GPRS including a packet gateway node (PGN) with an internet connection. The PGN acts as a mobile IP home agent (HA) with authentication of a MN handled by the GPRS/UMTS network before the PGN ever sees data traffic to establish a Mobile IP authentication key. An unauthenticated key exchange method such as Diffie-Hellman, the MVQ protocol or its one-pass variant (without certificates), or the Key Exchange Algorithm can be used to establish the shared key. The process may include performing a key exchange between the MN and the PGN via radio waves, the GPRS support node and the connection to establish a shared secret key and to establish an IPsec Security Association (SA) between the MN and the PGN. A hash of the key is performed at the PGN to obtain an authentication value for use in a Mobile IP protocol and using a security parameters index obtained from the SA as the Mobile IP for identifying the MN for authentication purposes. A Mobile IP registration request is sent from the MN to a Home Agent (HA) hosted in the PGN using the authentication value established. The Mobile IP registration request is received at the PGN. The message is authenticated using the authentication value and sending a Mobile IP registration reply to the MN.

### FIELD OF THE INVENTION

The invention relates generally to network systems and more particularly to communications between network peers across wireless local area networks (WLANS) as well as across a radio access network (RAN).

### BACKGROUND OF THE INVENTION

The growth in laptop computers and handheld computing devices (e.g., PDAs) has increased the need for users to seek network connectivity in many different locales. Wireless networks have thus gained popularity because of their convenience. However, security in a wireless networking environment is a serious concern. Because network traffic is broadcast over radio it becomes very easy for anyone with a radio to intercept this traffic for the purpose of gaining vital information or for masquerading as a legitimate user. Protecting these communications is a strong requirement in mobile computing.

For wireless LAN communications, the 802.11 standard specifies the Wired Equivalent Privacy (WEP) in order to address the security issues, primarily protecting data confidentiality, inherent in this technology. The WEP is an international standard and widely deployed. Unfortunately, it has been shown that WEP fails to achieve its data confidentiality goals leaving users vulnerable to a number of different attacks.

The WEP is a link-layer security protocol. This prevents link-layer eavesdropping but does not provide end-to-end security. Each mobile station or mobile node (MN) shares a key with the access point (AP). Each packet is encrypted with a shared key initialization vector (IV). Each packet includes an integrity check. If the integrity check fails the packet is rejected. Optionally, following the protocol can result in rejecting all unencrypted packets. The MNs and APs are not required to keep past state information. As a consequence one can replay packets. RC4 is the stream cipher used by the WEP. This expands a key into an infinite pseudorandom keystream. The WEP is a symmetric cipher, so the same key is used for encryption and decryption. The encrypted CRC-32 is used as the integrity check. However, one can change bits in the packet as the “integrity check” does not prevent packet modification. One could maliciously flip bits in packets to modify active streams. The TCP checksum is not quite linear, but one can guess right about half the time. As such, with known plaintext for a single packet one can send arbitrary traffic. A reuse of the RC4 keystream is problematic. One can use the IV to generate a different keystream for each packet by augmenting the key. Reuse of the IV is also problematic. With the same shared key used in both directions, at some installations all stations share the same key, i.e. a “network password”. Some implementations reset the IV to 0 when they are initialized. With this, it is easy to find collisions. With an IV collision, two packets P1 and P2 with same IV are present, C1=P1 xor RC4(k∥IV); C2=P2 xor RC4(k∥IV); C1 xor C2=P1 xor P2, where ‘xor’ is the bitwise exclusive or operation. As such, known plaintext P1 gives P2, or one may use statistical analysis to find P1 and P2. This is then even easier if one has three packets.

Another problem with the WEP is an implementation bug or a design flaw involving the use of random IVs. In the IV space there are 2²⁴ possibilities with collision after 4000 packets. As a rough estimate for a busy AP that sends 1000 packets/sec., one has a collision every 4 seconds. If one has 2²⁴ known plaintexts, one can decrypt every packet. This of course becomes more of a problem if stronger cryptography (i.e., 128-bit RC4) is deployed.

Some of the flaws above are based on the potential problems with someone obtaining plain text. Known plaintext can be obtained where IP traffic is relatively predictable. If there is an authentication challenge one can send packets from outside. The APs encrypt packets coming from the LAN before sending the packets over the air to the mobile nodes. The LAN eventually connects to Internet. An attack on the AP from both ends could take place, where one sends packets from the internet with known content to a wireless node to produce known plaintext. If one can guess a destination IP address in an encrypted packet the ability to flip bits in packets becomes problematic. If one (a hacker) can guess a destination IP address in an encrypted packet, one can flip bits to change an internet protocol (IP) to a contorted host (e.g., controlled by the hacker). This IP is then sent to the AP. Tricks can be used to adjust the IP checksum such that the AP forwards it to the controlled host (hacker host). This then is used to set the port to bypass the firewalls. The incorrect TCP checksum is not checked until the hacker sees the packet.

The security problems are a significant issue with regard to the use of the WEP. Further, the third generation wireless data access protocol GPRS/UMTS is also useful and could be advantageously used with a WLAN.

### SUMMARY AND OBJECTS OF THE INVENTION

This invention solves the inherent security flaws of WEP by making use of the Mobile IP standard [C. Perkins, IP Mobility Support, RFC 2002, Internet Engineering Task Force, October 1996] and IP Security (IPsec) protocol suite within the GPRS/UMTS infrastructure. The invention allows for seamless and secure roaming among wireless LANs and GPRS/UMTS networks. The invention makes use of a network infrastructure node, the packet gateway node (PGN) that is capable of functioning as a Gateway GPRS Serving Node network element as well as a Mobile IP Home Agent.

A mobile device or MN can be connected to the Internet by using wire or wireless network interfaces. However due to roaming, the device may change its network attachment each time it moves to a new link. It is therefore required that efficient protocols will be able to inform the network about this change in network attachment such that the internet data packets will be delivered in a seamless way (without any disruption of communication connection) to the new point of attachment. Such a problem is solved by use of the Mobile IP protocol (Mobile IP)—delivered by the Mobile IP IETF working group. Mobile IP is a scalable mechanism designed to accommodate device mobility within the Internet. It enables a mobile device to change its point of attachment to the Internet (with the help of Foreign Agents and a Home agent) while keeping an unchanging IP address called its Home IP address. Mobile IP does not require changes in the existing routing infrastructure and works well for mobility across homogeneous media and heterogeneous media.

The basic idea behind the Mobile IP protocol is for a mobile device or mobile node to always keep its home IP address, irrespective of its current attachment to the Internet. Packet addresses to the MN will always go via the home network intercepted by the home agent and then be forwarded on from there when necessary. When the mobile device is on its home network, it acts just like any other stationary device. When it is away from home, visiting a foreign network, the device registers its temporary location (care-of address) with the home agent situated on mobile's home network, which acts as an anchor point for the MN. Mobile IP can use two types of care of address: a foreign agent care-of address (an address from/of the foreign agent located in the visited network), and a co-located care-of address (an externally obtained care of address either through the Dynamic Host Configuration Protocol (DHCP) or any other means). Depending on the care-of address type, the MN registers itself i.e., its location with the home network i.e. home agent either directly or through a foreign agent's help.

After a successful registration, the HA will intercept packets destined to the MN device in its home network, and forward them to the MN's current point of attachment. The forwarding is done by “tunneling” the packets to the MN care-of address by encapsulating the original IP packet in another IP packet destined to the MN's care-of address. At the end of the tunnel, which is either at the foreign agent or at the MN itself, the packets are de-capsulated, thus providing the original IP packet before delivering this packet to the MN. Packets originating from the MN are sent in the same way as from any other stationary host (except in the case of a reverse tunnel).

The Internet Security Protocol (IPSec) is a suite of protocols designed to provide security services for the Internet Protocol (IP). Within the IPSec protocol, extensive use is made of mathematical algorithms for strong authentication and strong encryption. These algorithms are computationally intensive and constitute a significant processing overhead on data exchange. Consequently, specialized hardware is often used to accelerate the computations. The full set of authentication and encryption algorithms, as well as protocols supported by IPSec are well specified and can be found, for instance, in “The Big Book of IPSec RFCs”, Morgan Kaufmann, 2000.

The IPSec protocol suite provides an architecture with three overall pieces. An authentication header for IP lets communicating parties verify that data was not modified in transit and, depending on the type of key exchange, that it genuinely came from the apparent source. An encapsulating security payload (ESP) format for IP is used that encrypts data to secure it against eavesdropping during transit. A protocol negotiation and key exchange protocol, the Internet Key Exchange (IKE) is used that allows communicating parties to negotiate methods of secure communication. IKE implements specific messages from the Internet Security Association and Key Management (ISAKMP) message set. A security association (SA) is established between peers using IKE. The SA groups together all the things a processing entity at the peer needs to know about the communication with the other entity. This is logically implemented in the form of a Security Association Database. The SA, under the IPSec specifies:

the mode of the authentication algorithm used in the authentication header and the keys to that authentication algorithm;

the ESP encryption algorithm mode and the keys to that encryption algorithm;

the presence and size of (or absence of) any cryptographic synchronization to be used in that encryption algorithm;

how you authenticate communications (using what protocol, what encrypting algorithm and what key);

how you make communications private (again, what algorithm and what key);

how often those keys are to be changed;

the authentication algorithm, mode and transform for use in ESP plus the keys to be used by that algorithm;

the key lifetimes;

the lifetime of the SA itself;

the SA source address; and

a sensitivity level descriptor.

The SA provides a security channel to a network peer wherein the peer can be an individual unit, a group, another network or network resource. Various different classes of these security channels may be established with SAs. Using IPSec network entities can build secure virtual private networks. Using the ESP a secure virtual private network service called secure tunneling may be provided wherein the original IP packet header is encapsulated within the ESP. A new IP header is added containing the routable address of a security gateway allowing the private, non-routable IP addresses to be passed through a public network (the Internet), that otherwise wouldn't accept them. With tunneling the original source and destination addresses may be hidden from users on the public network. The IPSec protocol is operated between two entities in an IP-based network. In order for the entities to securely exchange data, they must

1. Agree on the type of protection to be used. The protection can be data origin authentication, data integrity or data confidentiality, or some combination.

2. For the chosen type of protection, agree on the algorithm(s) each entity will use as well as other parameters. The two entities authenticate one another and establish an ISAKMP Security Association and encryption/decryption key for exchange of shared, secret keys to be used for data exchange. The ISAMKP SA is used for securely passing messages that control the IPSec protocol.

3. For the chosen type of protection, the two entities agree on keying material which will operate within the algorithms to achieve the agreed upon level of security. The negotiation in this step is encrypted using the ISAKMP SA keys (like an IKE SA).

4. The entities apply the chosen type of protection in data exchanges and periodically change the keying material.

Steps 1 through 3 result in a IPSec Security Association (SA), distinct from the ISAKMP SA, between the two entities. These steps are roughly equivalent to the Internet Key Exchange protocol (IKE—Quick Mode,see RFC 2409). IPSec Security Associations are unidirectional. Thus if entity X and entity Y have completed an IKE, then entity X has a security association with entity Y and entity Y has a security association with entity X. These two associations are distinct and each carries a 32-bit number called the Security Parameter Index (SPI) that uniquely identifies the IPSec SA. The SPI is carried with each data packet exchanged between the two entities and allows the receiver to identify the set of previously agreed algorithms and keys.

For example, entity X would place entity Y's SPI in packets destined for entity Y, and vice versa. The recipient typically uses the SPI as an index into a security association database for retrieval of all information related to the SA.

Either according to a time limit, data exchange limit or exhaustion of a sequence number counter, the SA is refreshed with a new set of keying material. If either side wishes to remove an existing SA, they may send a delete notification for the specific SA. In the case when a failure causes an SA to become unreachable, it is particularly advantageous to inform the peer of this failure through a delete notification. This prevents the peer from sending data packets which would need to be discarded because of the lack of an ingress SA. This conserves processing resources at each peer.

A problem with Mobile IP is that a shared key (recommended to be 128 bits) must be used to authenticate the registration messages. The Mobile IP Specification assumes such a shared key exists but offers no guidance on its distribution. Typically, the shared key has been ‘pre-programmed’ manually. This entails programming the key for each MN to be used. This does not scale to large numbers of MNs very well.

According to the invention, authentication of a MN is handled by the GPRS/UMTS network before the PGN ever sees the traffic. This establishes a Mobile IP authentication key. As such, an unauthenticated key exchange method such as Diffie-Hellman, the MVQ protocol or its one-pass variant (without certificates), or the Key Exchange Algorithm can be used to establish the shared key. The result of the ephemeral key exchange is a shared key between the MN and the PGN. This key exchange need only occur once since the Mobile IP specification does not require re-keying of the authentication value. However, the method of the invention allows for the Mobile IP authentication value to be changed so as to provide increased security. In addition, the initial key forms the basis for subsequent key exchanges using standard's based protocols such as IPsec.

With a shared key in place, the Mobile IP authentication key is derived by performing an MD-5 hash of the shared key. So, pre-programming the authentication key is not needed and the authentication key need not remain static. This gives the solution stronger security and scalability. To subsequently encrypt traffic between the MN and the PGN, the method of the invention performs an authenticated key exchange, such as the IKE aggressive mode key exchange (very fast) using the shared key to establish a large encryption key and an SA.

The Mobile IP authentication key can be periodically changed by performing a key exchange across the GPRS/UMTS network in the manner previously described.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic diagram showing the network infrastructure system used according to the invention;

FIG. 2 is a schematic diagram showing a first phase of the process according to the invention;

FIG. 3 is a schematic diagram showing a second phase of the process according to the invention;

FIG. 4 is a schematic diagram showing a third phase of the process according to the invention;

FIG. 5 is a schematic diagram showing a fourth phase of the process according to the invention;

FIG. 6 is a schematic diagram showing a fifth phase of the process according to the invention;

FIG. 7 is a schematic diagram showing a sixth phase of the process according to the invention;

FIG. 8A is a first part of a diagram showing an example of the invention according to the invention; nad

FIG. 8B is a second part of a diagram showing of FIG. 8A.

### DESCRIPTION OF THE PREFERRED EMBODIMENTS

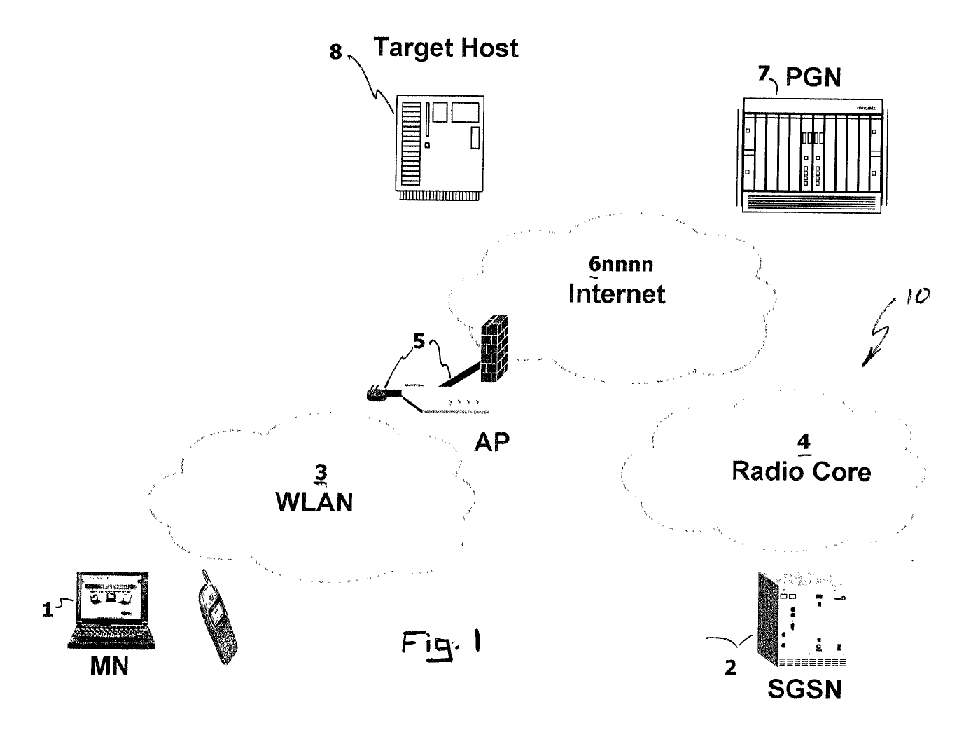

Referring to the drawings in particular, the invention operates within a network infrastructure shown in FIG. 1. A mobile node (MN) 1 is provided in the form of a laptop computer, a PDA or other mobile device. The MN 1 includes a radio frequency transceiver. This can be used with a WLAN 3. The WLAN 3 includes normal LAN components such as a server connecting nodes via wires such as twisted pair wires and operating using Ethernet (carrier sense multiple access/collision detection CSMA/CD or IEEE 802.3). With a WLAN at least one of the nodes is formed of an MN 1 with an access point 5. The access point (AP) 5 includes a radio transceiver connected by wires (such as twisted pair wires) to a hub, switch or router of the LAN. The wireless connection between AP 5 and MN 1 uses the IEEE 802.11 standard.

The MN 1 may also be used with a radio access network (RAN) generally designated 10. The RAN 10 includes a radio core 4 which includes the physical lines (or network) running from a serving GPRS support node (SGSN) 2 to the gateway GPRS support node, provided here as a packet gateway node (PGN) 7. The PGN 7 handles data traffic to and from mobile subscribers via RAN 10. Data traffic arriving from, or destined to users on the RAN 10 must use one or more data communications protocols specific to mobile users and the RAN technology. Traffic arriving from, or destined for the IP Router Network (e.g. the Internet) 6 can use a variety of IP-based protocols, sometimes in combination. The architecture of the PGN is able to provide protocol services to the RAN 10 and to the IP Network 6, scale to large numbers of users without significant degradation in performance and provide a highly reliable system. The PGN 7 also provides for management of mobile subscribers (e.g., usage restrictions, policy enforcement) as well as tracking usage for purposes of billing and/or accounting. The PGN 7 may be provided in various forms and preferably is provided as disclosed in application Ser. Nos. 09/811,204 and 09/816,883 (the content of application Ser. Nos. 09/811,204 and 09/816,883 are hereby incorporated by reference). The PGN 7 can function as both a Mobile IP home agent (HA) as well as a GGSN.

The SGSN 2 is connected to one or more cellular towers (radio frequency towers) via a Mobile Switching Center for radio communications for a particular cellular area. The radio core 4 provides the physical connection to the PGN 7. This allows users of the radio core 4 to access content from the Internet 6, such as through a host 8.

The invention uses the infrastructure shown in FIG. 1 to provide a secure communications system and method including secure communications through the WLAN 3. Further, the invention allows for roaming capabilities such that the MN 1 is provided with secure access possibilities both through the WLAN 3 and through the RAN 4.

Ultimately, the MN 1 wishes to access content at some target host 8 residing on, or accessible through the Internet 6 using the wireless technology of the WLAN 3. There are two networks through which the MN 1 can pass in order to reach the target host 8. The MN 1 may access the WLAN 3 using 802.11 technology and through the AP 5, traverse the Internet 6 to reach the target host 8. However, as noted earlier, this connection is not secure. Alternatively, the MN 1 may access the target host 8 by establishing a connection across an airlink to the SGSN 2 through the RAN 4 to the PGN 7. Once this link is established, the MN 1 can reach the Target Host through the Internet 6. Collectively, the airlink, SGSN 2, Radio Core or RAN 4 and PGN 7 constitute elements of a GPRS/UMTS network 12. Data flowing across the airlink is secured with encryption. The link from the SGSN 2 through the Radio Core 4 into the PGN 7 traverses a private network and this provides some measure of security.

The MN 1 desires the ability to roam between the GPRS/UMTS network 12 to access the target host 8 and the WLAN 3 to access the target host 8 in a secure manner. To manage this mobility, this invention makes use of Mobile IP for managing mobility and IPsec for managing security. A complete description of Mobile IP can be found in “Mobile IP”, James D. Solomon, Prentice Hall, 1998. The full specification for IPsec can be found in [“The Big Book of IPsec RFCs].

For an MN 1 to use Mobile IP and securely roam onto an 802.11 WLAN 3, it must establish a shared secret key to be used for both securing the data session and satisfying the authentication requirements of Mobile IP. However, one of the difficulties in implementing Mobile IP is that it was necessary to manually pre-program the 128-bit authentication value. For implementing this with many users, the time to pre-program can be extensive.

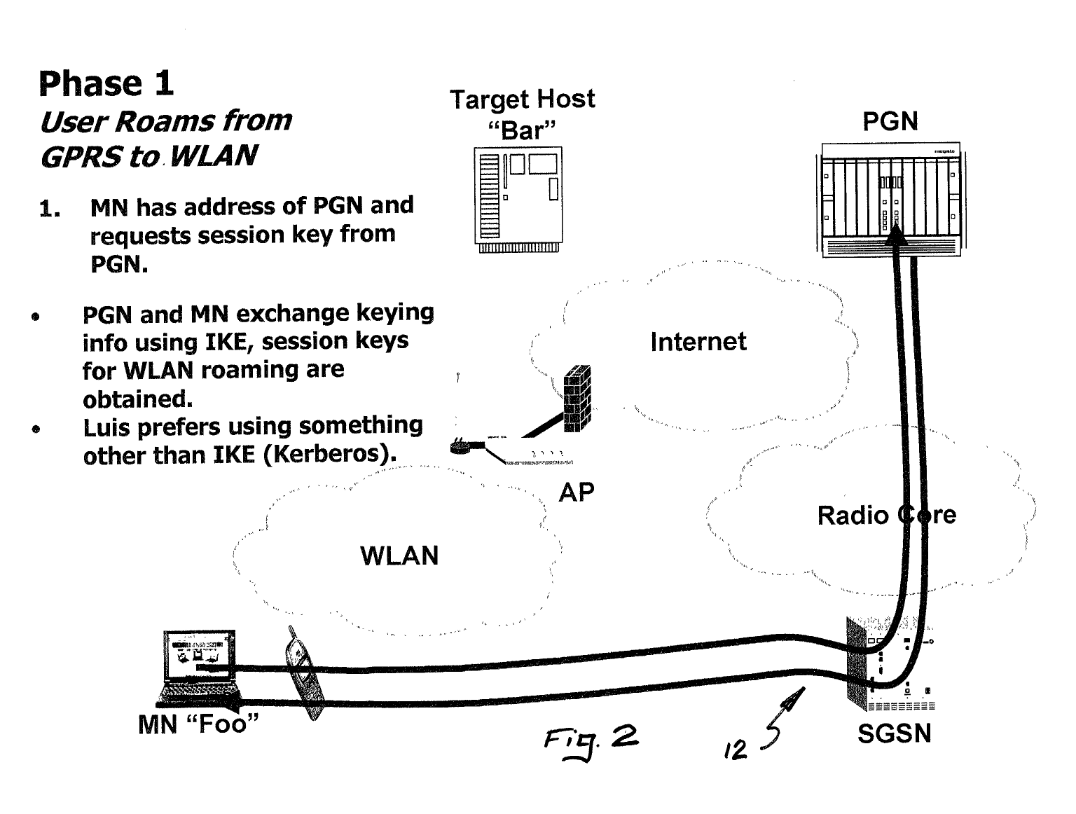

The invention allows users to roam from GPRS to WLAN using the PGN 7 as the home agent with the connection via WLAN 3 providing the care of address. As shown in FIG. 2, the MN 1 is provided with the address of the PGN 7 and requests a session key from the PGN 7. The PGN 7 and the MN 1 exchange keying information using some key exchange protocol. Examples of key exchange protocols are Diffie-Hellman, the MVQ protocol or its one-pass variant (without certificates), or the Key Exchange Algorithm can be used to establish the shared key (cf., Wilson and Menezes, “Authenticated Diffie-Hellman Key Agreement Protocols”, Proc. Selected Areas in Cryptography, Lecture Notes in Computer Science, 1556, (1999), 339-361.) With this operation, a derived session key for WLAN roaming is obtained by performing an MD-5 hash of the shared key. With a shared key established, an IPsec ESP tunnel between the MN 1 and the PGN 7 is established using the IKE Aggressive Mode.

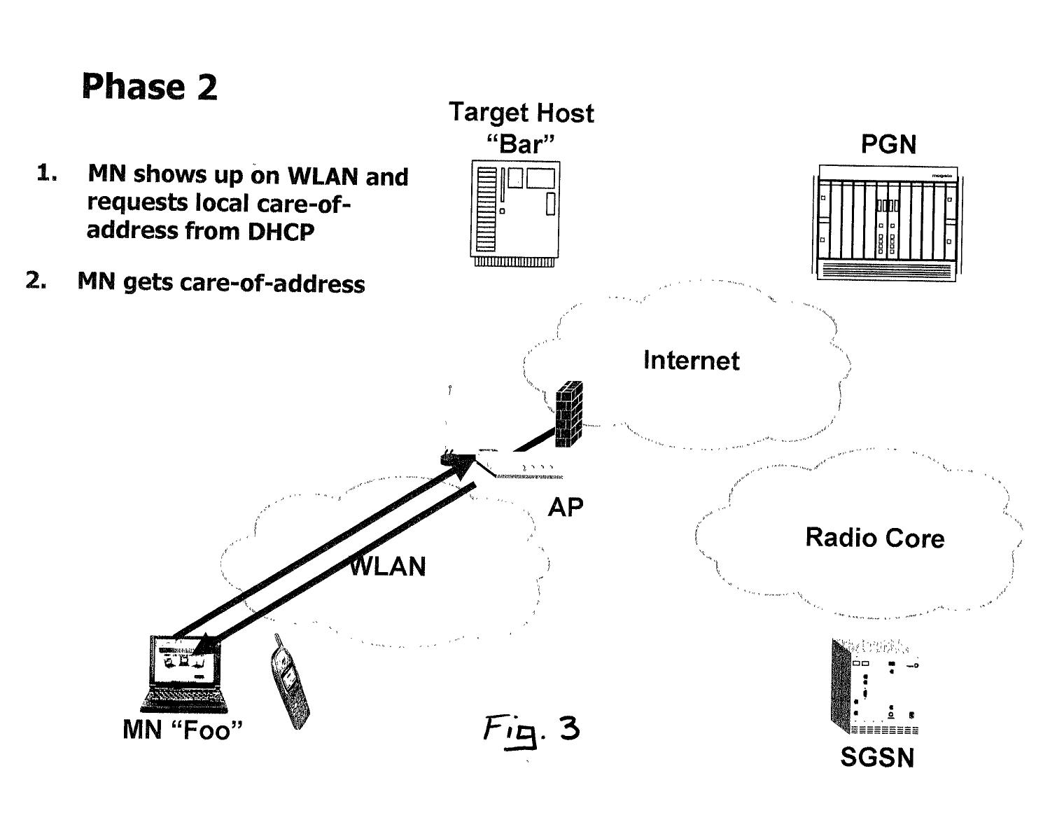

As shown in FIG. 3, the MN 1 connects through the WLAN 3 and requests a local care-of address (COA) from a DHCP server on the Internet. This COA is used for the Mobile IP protocol. The DHCP server then sends a COA across the Internet and across the WLAN 3.

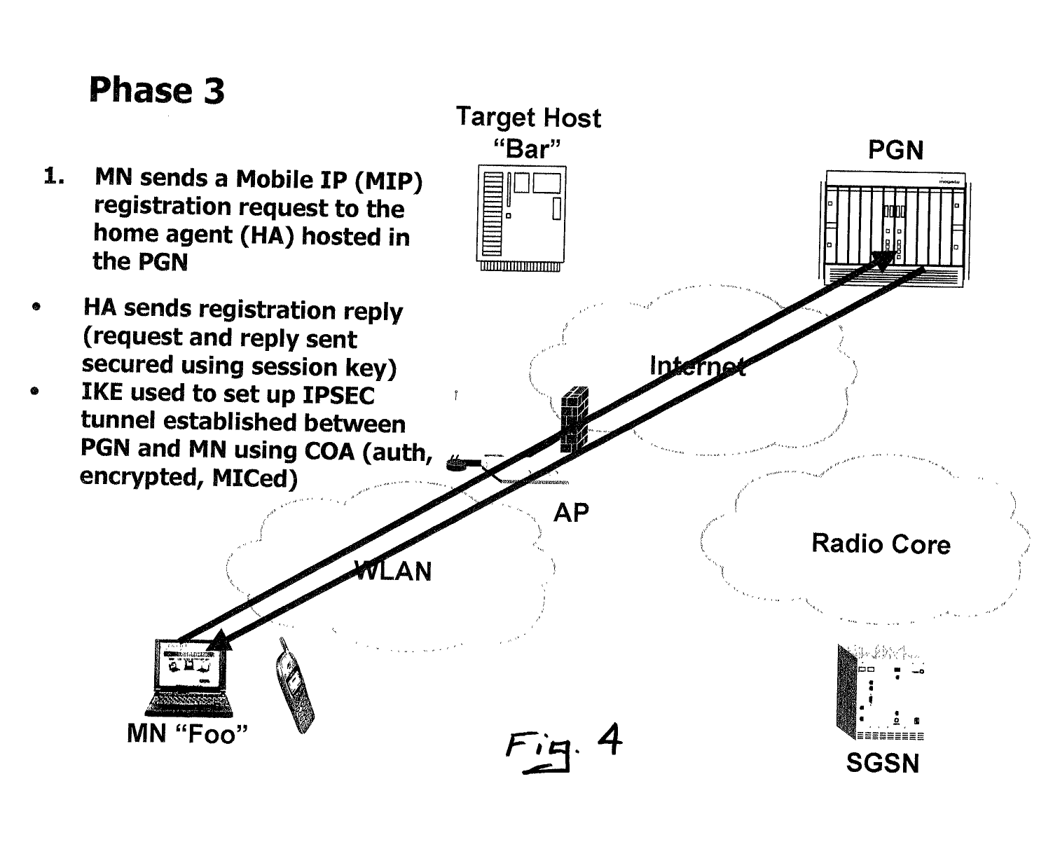

As shown in FIG. 4, the MN 1 sends a mobile IP registration request, authenticated with the derived session key, to the HA which is hosted in PGN 7. The HA verifies the message then sends a registration reply authenticated with the same derived session key. The mobile IP registration request and the mobile IP registration reply can be sent as secure transmissions using the key from the IKE Aggressive Mode exchange. However, because a session key exists, the Mobile IP registration messages can be sent in the clear since the derived session key is used for authenticating the messages. According to the preferred embodiment IKE is used to set up an IPsec tunnel established between the PGN 7 and the MN 1 using the COA to securely transit traffic across the WLAN. The secure transmissions has authentication, encryption and message integrity, indicated by a Message Integrity Code (MIC).

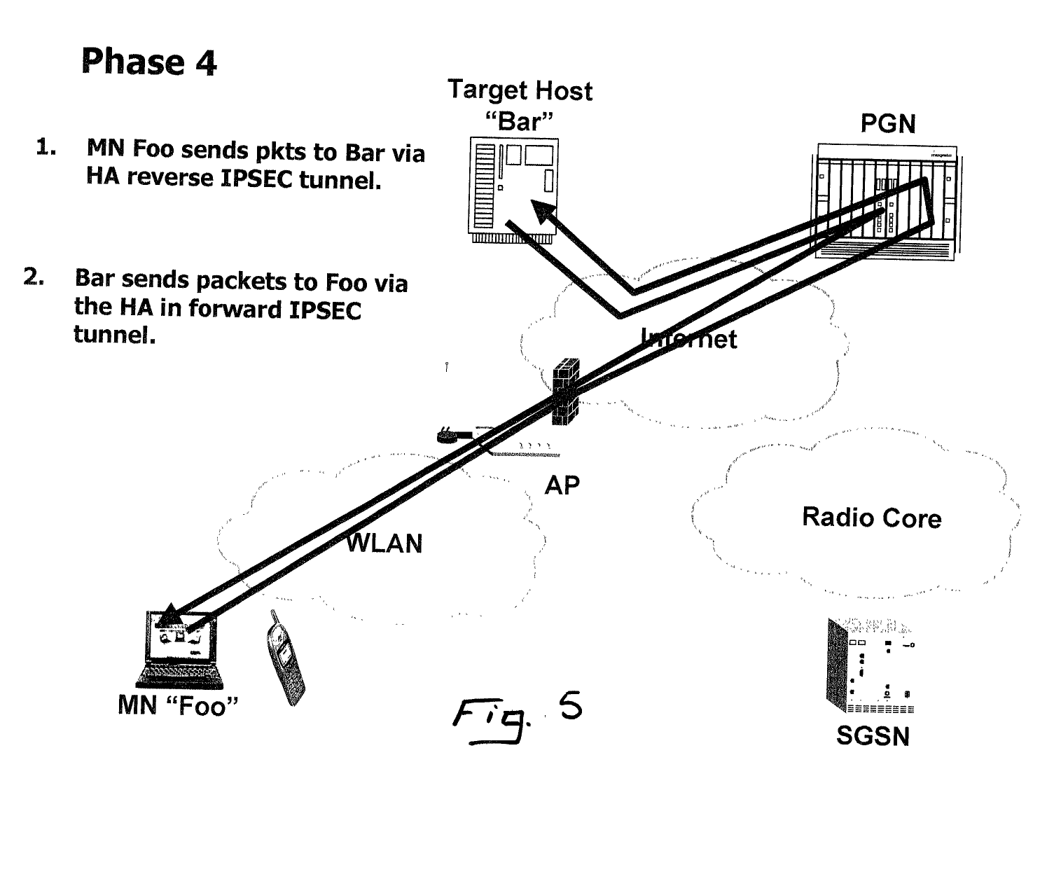

FIG. 5 shows the state of the process and system according to the invention wherein the MN 1 sends packets to the target host 8 via the HA hosted by PGN 7, and also by the Internet 6 and the WLAN 3 with a access point. The entire data exchange across the WLAN is secure. Similarly, target host 8 sends packets to MN 1 via the HA hosted on PGN 7, via the Internet and via WLAN 3.

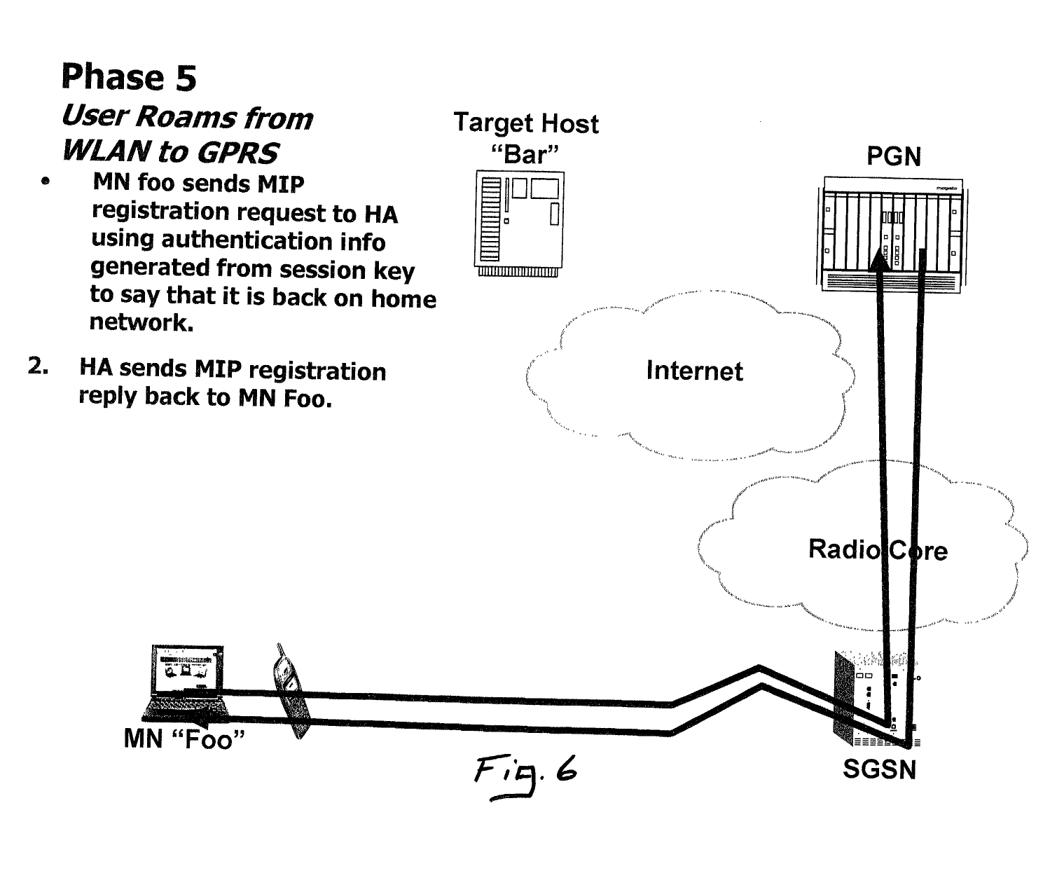

FIG. 6 shows the subsequent state wherein the MN 1 can roam from the WLAN 3 to the GPRS. The MN 1 sends a mobile IP registration request to the HA using the authentication information generated from a session key. According to the method of the invention the COA is used while connected to the WLAN 3. Subsequently, the MN 1 leaves the WLAN3 and indicates that MN 1 is back home on the GPRS/UMTS network. The HA then sends a mobile IP registration reply back to the MN 1.

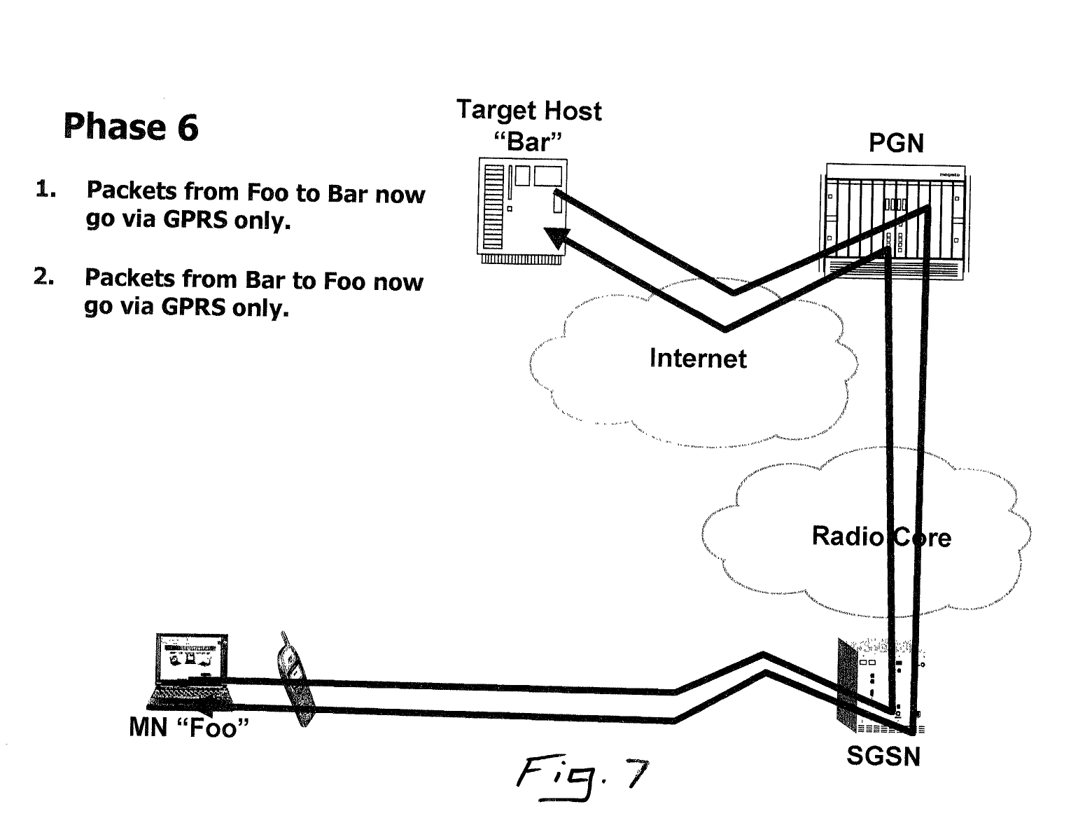

FIG. 7 shows further data transfer using the GPRS. Packets from the MN 1 to the target host 8 go via the GPRS only. Packets from the target host 8 now go to the MN 1 via the GPRS only. However, the MN1 can roam including again connecting to the WLAN 3.

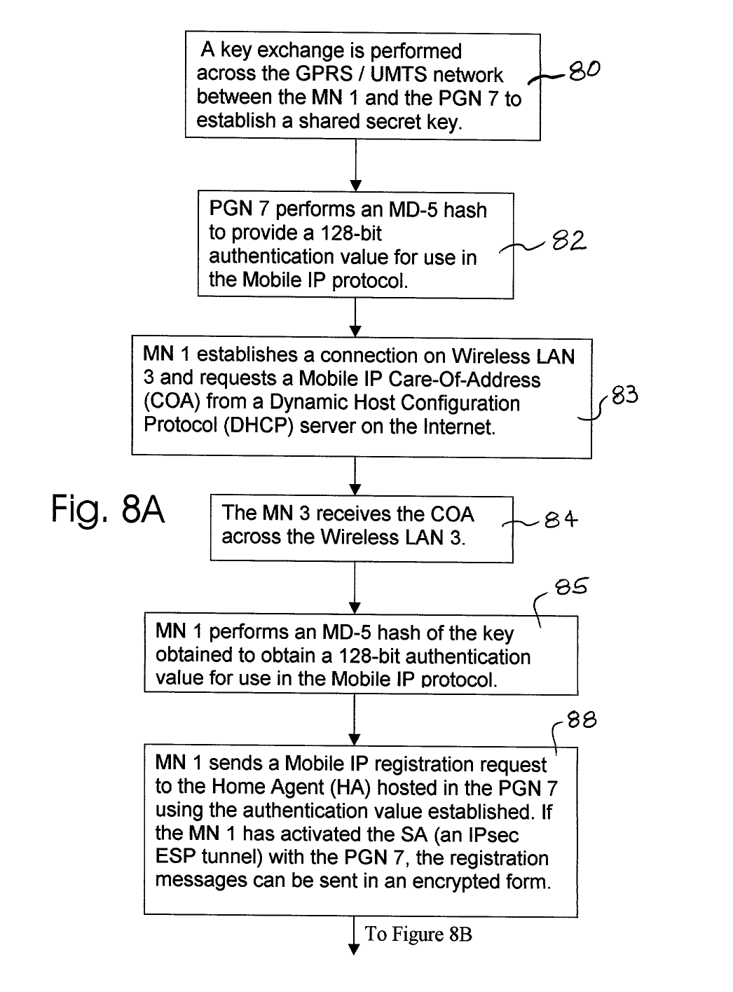

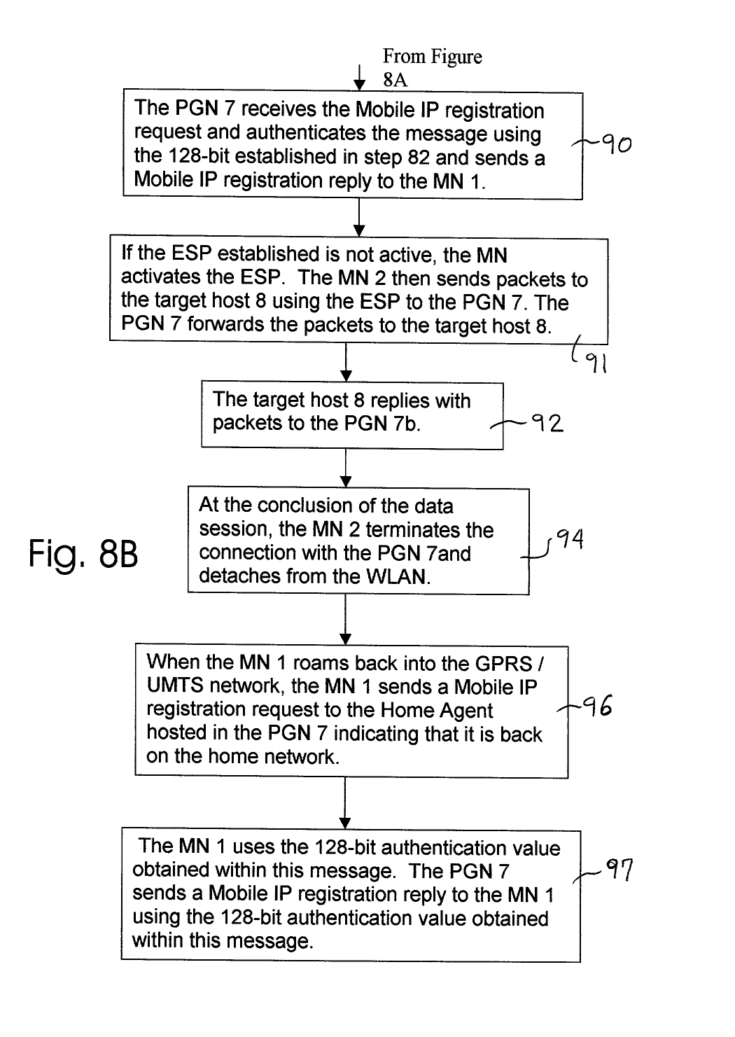

FIGS. 8A and 8B show a preferred method according to the invention. This preferred method is as follows:

As indicated at 80, The MN 1 performs a key exchange across the GPRS/UMTS network with the PGN 7 to establish a shared secret key and an SPI to be used for subsequent identification of the key. Because this key is established outside of IPsec, the resulting shared key and Security Parameters Index (SPI) are identified within the PGN and the MN as a pre-shared secret to the IPsec applications resident in each. The SPI is used as an index into a data structure to identify the parameters of the security association.

The PGN 7 performs a MD-5 hash at 82 of the key obtained in step 80. The result of the MD-5 hash is a 128-bit authentication value for use in the Mobile IP protocol. The SPI obtained in Step 80 is used as the Mobile IP SPI for identifying the MN 1 for authentication purposes.

The MN 1 establishes a connection on Wireless LAN 3 at step 83 and requests a Mobile IP Care-Of-Address (COA) from a Dynamic Host Configuration Protocol (DHCP) server on the Internet. The DHCP is based on device addresses and is used to allocate IP addresses and other configuration information automatically for networked systems.

At step 84 the MN 3 receives the COA across the Wireless LAN 3.

The MN 1 performs an MD-5 hash at step 85 of the key obtained in Step 80 to obtain a 128-bit authentication value for use in the Mobile IP protocol.

At step 88 the MN 1 sends a Mobile IP registration request to the Home Agent (HA) hosted in the PGN 7 using the authentication value established in step 85. If the MN 1 has activated the SA (an IPsec ESP tunnel) with the PGN 7, the registration messages can be sent in an encrypted form. Otherwise, the registration messages can be sent in the clear.

The PGN 7 receives the Mobile IP registration request at step 90 and authenticates the message using the 128-bit established in step 82 and sends a Mobile IP registration reply to the MN 1.

If the ESP established in Step 80 is not active, the MN activates the ESP at step 91. The MN 2 then sends packets to the target host 8 using the ESP to the PGN 7. The PGN 7 forwards the packets to the target host 8.

The target host 8 replies with packets to the PGN 7 at step 92. The PGN 7 then forwards these packets using the ESP to the MN 1.

At the conclusion of the data session, the MN 2 terminates the connection with the PGN 7and detatches from the WLAN at step 94.

At step 96, when the MN 1 roams back into the GPRS/UMTS network, the MN 1 sends a Mobile IP registration request to the Home Agent hosted in the PGN 7 indicating that it is back on the home network. The MN 1 uses the 128-bit authentication value obtained in step 85 for within this message.

At step 97, the PGN 7 sends a Mobile IP registration reply to the MN 1 using the 128-bit authentication value obtained in Step 82 within this message.

The system and method of the invention provides several advantages for wireless secure communications, including the ability to roam between a WLAN and a GPRS/UMTS connection. The system and method provide a solution to the security problem inherent in wireless LANs using purely standards based mechanisms. The system and method are particularly advantageous using the described PGN 7 based on its function as both a Mobile IP home agent as well as a GGSN.

The system and method provide conveniences, particularly as to obtaining the 128-bit authentication value without the burdensome step of manual pre-programming. In the solution according to the method and system of the invention, authentication is handled by the GPRS/UMTS network before the PGN ever sees the traffic. The method and system of the invention can perform a key exchange using any method to establish a large key and use this to create an IPsec pre-shared secret and SPI. The Mobile IP authentication key is then derived from the IPsec key and the MD-5 hash transforms it into a unique 128-bit value. The pre-programming of the authentication value is not needed and the authentication value does not have to remain static. Re-keying can occur in a variety of ways. A key exchange across the GPRS/UMTS network can be performed periodically to establish a new IPsec pre-shared secret and a Mobile IP authentication key by the method described earlier. Alternatively, the IPsec pre-shared secret can be used within the IKE Aggressive Mode of key exchange to periodically change the Mobile IP authentication value. This gives the solution according to the system and method of the invention stronger security.

While specific embodiments of the invention have been shown and described in detail to illustrate the application of the principles of the invention, it will be understood that the invention may be embodied otherwise without departing from such principles.

What is claimed is:

1. A wireless data network process, comprising the steps of:
providing a wireless local area network (WLAN) with a wireless access node, an internet connection and a mobile node (MN) with a wireless transceiver;
providing a serving GPRS support node with a radio network connection to a Gateway GPRS support packet gateway node (PGN) having a connection to the internet;
performing a key exchange between the MN and the PGN via radio waves, the GPRS support node and the connection to establish a shared secret key and to establish an IPsec Security Association (SA) between the MN and the PGN;
performing a hash of the key obtained at the PGN to obtain an authentication value for use in a Mobile IP protocol and using a security parameters index obtained from the SA as the Mobile IP for identifying the MN for authentication purposes;
performing a hash of the key obtained at the MN to obtain an authentication value for use in a Mobile IP protocol;
sending a Mobile IP registration request from the MN to a Home Agent (HA) hosted in the PGN using the authentication value established;
receiving the Mobile IP registration request at the PGN and authenticating the message using the authentication value and sending a Mobile IP registration reply to the MN.

2. A process according to claim 1, wherein said step of performing a key exchange includes performing a key exchange and subsequently using the Internet Key Exchange (IKE) protocol with the MN requesting Encapsulated Security Protocol (ESP) for establishing the SA.

3. A process according to claim 2, further comprising:
receiving the Mobile IP registration reply at the MN and if the ESP established is not active, activating the ESP at the MN;
sending data packets from the MN to a target host on the internet using the ESP to the PGN with the PGN forwarding the packets to the target host;
replying by sending reply packets from the target host to the PGN with the PGN forwarding the reply packets using the ESP to the MN.

4. A process according to claim 3, further comprising:
establishing a connection of the MN on the Wireless LAN;
requesting a Mobile IP Care-Of-Address (COA) from Dynamic Host Configuration Protocol (DHCP) server on the Internet;
receiving the COA at the MN from across the Wireless LAN, wherein said step of sending data packets from the MN to a target host is via the wireless LAN connection to the internet and said step of replying by sending reply packets from the target host to the PGN is via the internet to the wireless LAN.

5. A process according to claim 4, further comprising:
terminating the connection with the PGN and detatching from the WLAN after the conclusion of the data session to the MN 2.

6. A process according to claim 4, further comprising:
roaming with the MN into a region of the radio network and sending a message from the MN a Mobile IP registration request to the Home Agent hosted in the PGN indicating that the MN is on the home network and using the authentication value obtained within the message;
sending a Mobile IP registration reply from the PGN to the MN using the authentication value obtained.

7. A process according to claim 1, wherein said authentication value is a 128 bit authentication value.

8. A process according to claim 2, wherein the Mobile IP registration request can be sent via the established ESP.

9. A process according to claim 2, wherein the Mobile IP registration request is sent without the established ESP.

10. A wireless network system, comprising:
a mobile node with a wireless transceiver;
a serving GPRS support node (SGPRS);
a radio access network;
a gateway GPRS including a packet gateway node (PGN) with an internet connection, the PGN being capable of acting as a mobile IP home agent (HA);
a wireless local area network (WLAN) with a wireless access node and an internet connection;
at least one or both of a connection from the MN to the SGPRS and a connection between the MN and the WLAN;
keying established between the PGN and the MN using the MN to the SGPRS connection to form an IPSec Security Association between the MN and the PGN with a security parameters index obtained from the SA for identifying the MN;
a Mobile IP care-of-address obtained from a DHCP server through the connection between the MN and the WLAN;
an authentication value at the PGN for use in the IP mobile protocol formed by a MD-5 hash of the keying established between the PGN and the MN;
an authentication value at the MN for use in the IP mobile protocol formed by a MD-5 hash of the keying established between the PGN and the MN;
a Mobile IP registration based on a request message from the MN to the PGN with the HA hosted in the PGN using the authentication value established and with the PGN authenticating the message using the authentication value with a Mobile IP registration reply sent from the PGN to the MN.

11. A system according to claim 10, wherein said authentication value is a 128 bit authentication value.

12. A system according to claim 10, wherein said request message is sent from the MN to the PGN via the WLAN and a connection from the WLAN to the PGN over the internet.

13. A wireless network system, comprising:
a mobile node with a wireless transceiver;
a serving GPRS support node (SGPRS);
a radio access network;
a gateway GPRS including a packet gateway node (PGN) with an internet connection, the PGN being capable of acting as a mobile IP home agent (HA) with authentication of a MN handled by the GPRS/UMTS network before the PGN ever sees data traffic to establish a Mobile IP authentication key, wherein an unauthenticated key exchange method such as Diffie-Hellman, the MVQ protocol or its one-pass variant (without certificates), or the Key Exchange Algorithm can be used to establish the shared key.

14. A system according to claim 10, wherein in addition, the initial key forms the basis for subsequent key exchanges using a standard's based protocol.

15. A system according to claim 14, wherein the standard's based protocol is IPsec.

16. A system according to claim 15, wherein with a shared key in place, the Mobile IP authentication key is derived by performing an MD-5 hash of the shared key whereby pre-programming of the authentication key is not needed and the authentication key need not remain static.

17. A system according to claim 16, wherein subsequent traffic between the MN and the PGN is encrypted using an authenticated key exchange with the IKE aggressive mode key exchange (very fast) using the shared key to establish a large encryption key and an SA.

18. A system according to claim 17, further comprising:
a wireless local area network (WLAN) with a wireless access node and an internet connection;
a connection between the MN and the WLAN;
a Mobile IP care-of-address obtained from a DHCP server through the connection between the MN and the WLAN.

19. A system according to claim 18, wherein said authentication value is a 128 bit authentication value.
